(19) United States
(12) Patent Application Publication
(10) Pub. No.: US 2019/0278303 A1
(43) Pub. Date: Sep. 12, 2019

(54) METHOD OF CONTROLLING OBSTACLE AVOIDANCE FOR UNMANNED AERIAL VEHICLE AND UNMANNED AERIAL VEHICLE

(71) Applicant: SZ DJI TECHNOLOGY CO., LTD., Shenzhen (CN)

(72) Inventor: Yao ZOU, Shenzhen (CN)

(21) Appl. No.: 16/418,067

(22) Filed: May 21, 2019

Related U.S. Application Data
(63) Continuation of application No. PCT/CN2016/106995, filed on Nov. 23, 2016.

(51) Int. Cl. G05D 1/10; G05D 1/08; G05D 1/00; B64C 39/02

(52) U.S. Cl. CPC G05D 1/106; G05D 1/0808; B64C 2201/141; G05D 1/0055; B64C 39/024; G05D 1/0094

(57) ABSTRACT

A method of controlling obstacle avoidance for an unmanned aerial vehicle (UAV) includes obtaining current attitude information of the UAV, where the UAV includes a craft body and a detection apparatus attached to the craft body, and controlling a detection direction of the detection apparatus to be in a preset direction according to the current attitude information of the UAV.

### CROSS-REFERENCE TO RELATED APPLICATION

This application is a continuation of International Application No. PCT/CN2016/106995, filed on Nov. 23, 2016, the entire content of which is incorporated herein by reference.

### TECHNICAL FIELD

The embodiments of the present disclosure relate to the field of unmanned vehicle and, in particular, to a method of controlling obstacle avoidance for an unmanned aerial vehicle and the unmanned aerial vehicle.

### BACKGROUND

In the current technologies, an unmanned aerial vehicle (UAV) is equipped with a radar, and the radar can detect whether there is an obstacle in front of the UAV when the UAV is flying in air. Compared to obstacles at a lower altitude, there are fewer obstacles at a higher altitude. At the lower altitude, common obstacles include wires, utility poles, shrubs, and vegetation, etc.

Therefore, when the UAV is flying at the lower altitude, the function of the radar is more important. However, in current technologies, a detection direction of the radar can be easily affected by an angle of the UAV itself, i.e., the radar detection direction changes as the angle of the UAV changes. As a result, the radar cannot accurately detect obstacles in front of the UAV, which reduces safety of the UAV during flight.

### SUMMARY

In accordance with the disclosure, there is provided a method of controlling obstacle avoidance for an unmanned aerial vehicle (UAV). The method includes obtaining current attitude information of the UAV, where the UAV includes a craft body and a detection apparatus attached to the craft body, and controlling a detection direction of the detection apparatus to be in a preset direction according to the current attitude information of the UAV.

Also in accordance with the disclosure, there is provided a UAV. The UAV includes a craft body, a propulsion system mounted at the craft body, a detection apparatus attached to the craft body, and a flight controller. The propulsion system can provide a flight power. The detection apparatus can detect an obstacle near the UAV. The flight controller is communicatively connected to the propulsion system and the detection apparatus. The flight controller can obtain current attitude information of the UAV and control a detection direction of the detection apparatus to be in preset direction according to the current attitude information of the UAV.

Also in accordance with the disclosure, there is provided a method of controlling obstacle avoidance for an agriculture UAV. The method includes obtaining a current pitch angle of a craft body of the agricultural UAV and controlling a detection direction of a radar of the agricultural UAV to be in a horizontal direction, according to the current pitch angle of a craft body.

### DESCRIPTION OF THE DRAWINGS

FIG. 1 is a structural diagram of an unmanned aerial vehicle (UAV) according to current technologies.

FIG. 2 is an application scenario of an obstacle avoidance control for the UAV according to the current technologies.

FIG. 3 is another application scenario of the obstacle avoidance control for the UAV according to the current technologies.

FIG. 4 is a flowchart of an example of a method of controlling obstacle avoidance for a UAV according to some embodiments of the present disclosure.

FIG. 5 is a structural diagram of an example of a UAV according to some embodiments of the present disclosure.

FIG. 6 is a structural diagram of another example of a UAV according to some other embodiments of the present disclosure.

FIG. 7 is a structural diagram of another example of a UAV according to some other embodiments of the present disclosure.

FIG. 8 is an application scenario of the obstacle avoidance control for a UAV according to some embodiments of the present disclosure.

FIG. 9 is another application scenario of the obstacle avoidance control for a UAV according to some other embodiments of the present disclosure.

FIG. 10 is a structural diagram of another example of a UAV according to some other embodiments of the present disclosure.

FIG. 11 is a structural diagram of another example of a UAV according to some other embodiments of the present disclosure.

FIG. 12 is a flowchart of an example of a method of controlling obstacle avoidance for an agricultural UAV according to some embodiments of the present disclosure.

### REFERENCE NUMERALS FOR MAIN COMPONENTS

1—Pitch angle direction

2—Detection direction of a detection apparatus

3—Rotation direction of the detection apparatus

4—First rotation direction of a rotation apparatus

5—Second rotation direction of the rotation apparatus

6—First pitch angle direction of a craft body

7—Third rotation direction of the rotation apparatus

8—Second pitch angle direction of the craft body

9—Fourth rotation direction of the rotation apparatus

11—Craft body

12—Detection apparatus

13—Obstacle

14—Rotation apparatus

100—UAV

107—Motor

106—Propeller

117—Electronic speed control

118—Flight controller

108—Sensing system

110—Communication system

102—Supporting apparatus

104—Photography apparatus

112—Ground station

114—Antenna

116—Electromagnetic wave

### DETAILED DESCRIPTION

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without creative efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Example embodiments will be described with reference to the accompanying drawings, in which the same numbers refer to the same or similar elements unless otherwise specified.

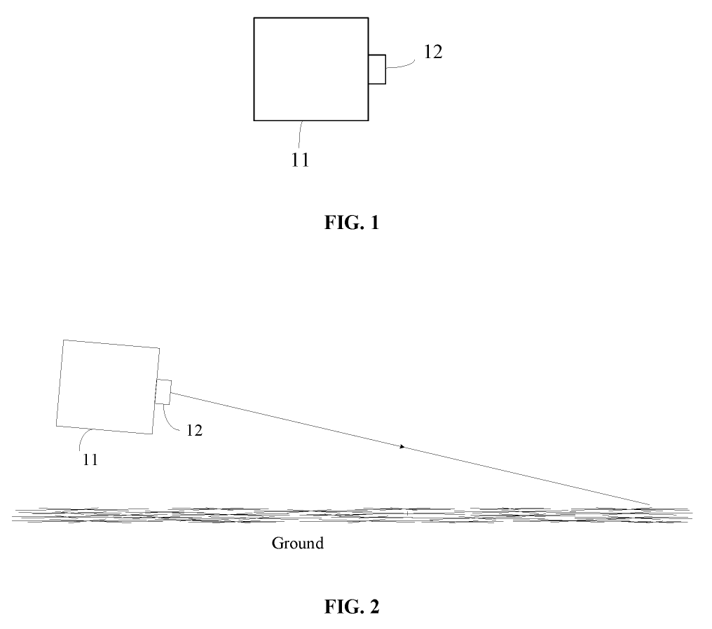

FIG. 1 is a structural diagram of an example of an unmanned aerial vehicle (UAV) according to current technologies. FIG. 2 is an application scenario of an obstacle avoidance control for the UAV according to current technologies. FIG. 3 is another application scenario of the obstacle avoidance control for the UAV according to the current technologies. As shown in FIG. 1, the UAV includes a craft body 11 and a detection apparatus 12 disposed at the craft body 11. The detection apparatus 12 may be a radar, ultrasonic sensor, time of flight (ToF) sensor, or binocular vision sensor, etc., configured to detect surrounding obstacles of the UAV. Specifically, the detection apparatus 12 can detect obstacles in front of the UAV. In the current technologies, an attitude of the UAV during the flight is constantly adjusted, and the attitude includes one or more of: a pitch angle, a roll angle, and a yaw angle. Especially, the pitch angle is often adjusted. The pitch angle of the detection apparatus 12 changes along with a change of the pitch angle of the craft body 11. As shown in FIG. 2, when the pitch angle of the craft body 11 is negative, the detection direction of the detection apparatus 12 deviates downward from the horizontal direction, and the detection apparatus 12 may take the ground as the detected obstacle, and activates an obstacle avoidance function of the UAV, e.g., controlling the UAV to stop flying forward, resulting in the obstacle avoidance function of the UAV being activated by mistake.

In another example, as shown in FIG. 3, the UAV of the current technologies is in a braking control process, the pitch angle of the UAV is positive, and the detection direction of the detection apparatus 12 deviates upward from the horizontal direction. At this time, there may be an obstacle 13 in front of the UAV. However, because the detection direction of the detection apparatus 12 deviates from the horizontal direction, the detection apparatus 12 cannot accurately detect the obstacle 13 in front of the UAV, and if the UAV continues flying forward, the UAV may hit the obstacle 13.

According to FIG. 2 and FIG. 3, in the current technologies, the detection direction of the detection apparatus can be affected by the pitch angle of the UAV. When the pitch angle of the UAV is not zero, the detection direction of the detection apparatus deviates from the horizontal direction. In addition, the detection direction of the detection apparatus changes along with the change of the pitch angle of the UAV. Thus, the detection apparatus cannot accurately detect the obstacle in front of the UAV, thereby decreasing the safety during a flight process of the UAV, e.g., the safety during a low altitude flight process of the UAV.

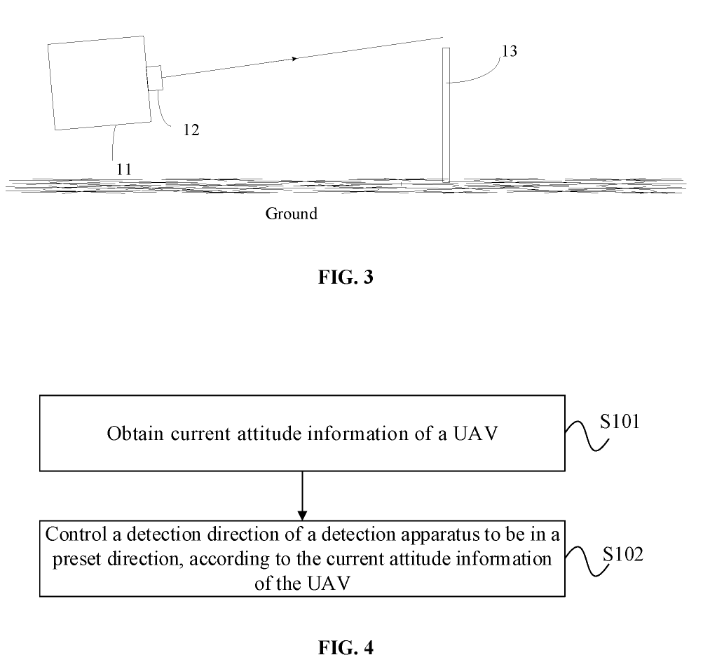

One aspect of the present disclosure provides a method of controlling obstacle avoidance for a UAV. FIG. 4 is a flowchart of an example of a method for controlling obstacle avoidance a UAV according to some embodiments of the present disclosure. As shown in FIG. 4, at S101, current attitude information of the UAV is obtained.

The UAV includes a craft body and a detection apparatus disposed at the craft body. The detection apparatus can be configured to detect obstacles around the UAV. The current attitude information of the UAV can be the current attitude information of the craft body or the current attitude information of the detection apparatus.

The attitude information can include one or more of: the pitch angle, the roll angle, and the yaw angle.

During the flight of the UAV, attitude information such as the pitch angle, the roll angle, and the yaw angle of the craft body may change, and attitude information such as the pitch angle, the roll angle, and the yaw angle of the detection apparatus may also change. The principle of the method of controlling obstacle avoidance for the UAV consistent with the present disclosure is described according to changes in the pitch angle of the craft body and/or the pitch angle of the detection apparatus.

At S102, according to the current attitude information of the UAV, a detection direction of the detection apparatus is controlled to allow the detection direction to be in a preset direction.

In some embodiments, the detection direction of the detection apparatus can be kept in the horizontal direction. A detection beam emitted by the detection apparatus can be kept pointing in the horizontal direction, or the detection direction of the detection apparatus changes with the change in the pitch angle of the craft body first, and then adjust to the preset direction. For example, the change of the pitch angle of the craft body can cause a change of the pitch angle of the detection apparatus, so that the detection direction of the detection apparatus deviates from the horizontal direction, i.e., the detection apparatus of the direction of detection changes with the change in the pitch angle of the craft body. The detection direction of the detection apparatus can be controlled by a controller that is connected to the detection apparatus, so that the detection direction of the detection apparatus can be controlled in the horizontal direction, or with a preset angle with the horizontal direction.

The method of controlling the obstacle avoidance for the UAV can be executed by a flight controller or a control module with a control function in the UAV. In some embodiments, the flight controller may be configured to execute the method. The flight controller may control the detection direction of the detection apparatus according to the current attitude information of the UAV. Below are two example scenarios that the flight controller controls the detection direction of the detection apparatus.

In one example, the current attitude information of the UAV is the pitch angle of the detection apparatus, and the detection direction of the detection apparatus is controlled according to the pitch angle of the detection apparatus.

In another example, the current attitude information of the UAV is the pitch angle of the craft body, and the detection direction of the detection apparatus is controlled according to the pitch angle of the craft body.

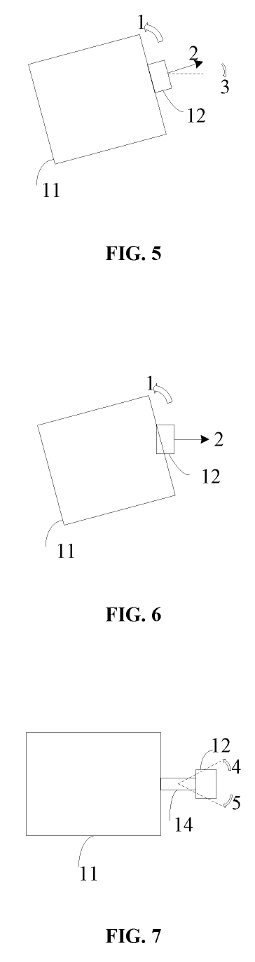

As shown in FIG. 5, both the pitch angle (arrow 1) of the craft body 11 and the pitch angle of the detection apparatus 12 are not zero, causing the detection direction (arrow 2) of the detection apparatus 12 to deviate from the horizontal direction. The detection direction of the detection apparatus 12 may be controlled according to the pitch angle of the detection apparatus 12, or the detection direction of the detection apparatus 12 may be controlled according to the pitch angle of the craft body 11. The flight controller of the UAV includes an inertial measurement unit and a gyroscope. The inertia measurement unit and the gyroscope can be configured to detect the acceleration, the pitch angle, the roll angle, the yaw angle, etc. of the UAV. In addition, the inertia measurement unit may also be configured to detect the pitch angle, the roll angle, and the yaw angle of the detection apparatus 12. The pitch angle of the craft body 11 or the pitch angle of the detection apparatus 12 can be detected by the inertia measurement unit. The flight controller can control the detection direction of the detection apparatus 12 based on the pitch angle of the craft body 11 or the pitch angle of the detection apparatus 12. For example, the flight controller can control a rotation of the detection apparatus 12 to control the detection direction of the detection apparatus 12. As shown in FIG. 5, the detection apparatus 12 can rotate along a direction indicated by arrow 3. As shown in FIG. 6, after the detection apparatus 12 rotates, the detection direction (arrow 2) of the detection apparatus 12 is the same as the horizontal direction.

Assume that a direction deviating upward with respect to the horizontal direction is in a positive direction, and a direction deviating downward with respect to the horizontal direction is in a negative direction. Referring to FIG. 5 and FIG. 6, when the pitch angle of the craft body 11 or the pitch angle of the detection apparatus 12 is positive, the detection apparatus 12 can rotate along a direction opposite to the pitch angle, i.e., along the negative direction (or with a negative rotation angle). When the pitch angle of the craft body 11 or the pitch angle of the detection apparatus 12 is negative, the detection apparatus 12 can rotate along a direction opposite to the pitch angle, i.e., along the positive direction (or with a positive rotation angle). In addition, a magnitude of the pitch angle of the craft body 11 or the pitch angle of the detection apparatus 12 can be equal to a magnitude of a rotation angle of the detection apparatus 12.

According to the current attitude information of the UAV, the detection direction of the detection apparatus can be controlled to ensure that the detection direction of the detection apparatus is in a preset direction, e.g., the horizontal direction. Thus, the detection direction of the detection apparatus does not change along with the change of the current attitude of the UAV. As such, the detection apparatus can accurately detect the obstacle in front of the UAV, thereby improving the safety of the UAV during flight.

Another aspect of the present disclosure provides a method of controlling the obstacle avoidance for a UAV. FIG. 7 is a structural diagram of an example of a UAV according to some embodiments of the present disclosure. As shown in FIG. 7, the detection apparatus 12 is attached to the craft body 11 through a rotation apparatus 14. The detection apparatus 12 is connected to the rotation apparatus 14. The rotation apparatus 14 can rotate to deviate upward from the horizontal direction (arrow 4, which indicates a first rotation direction of the rotation apparatus 14). The rotation apparatus 14 can also rotate to deviate downward from the horizontal direction (arrow 5, which indicates a second rotation direction of the rotation apparatus 14).

When the rotation apparatus 14 rotates, the detection apparatus 12 can rotate together with the rotation apparatus 14. In some embodiments, as shown in FIG. 5 and FIG. 6, controlling the detection direction of the detection apparatus 12 can be achieved by controlling the rotation of the detection apparatus 12. In addition, controlling the detection direction of the detection apparatus 12 can also achieved by controlling the rotation of the rotation apparatus 14. As such, the detection direction of the detection apparatus 12 can be the same as the horizontal direction. Specially, the flight controller can be configured to control the rotation of the rotation apparatus 14, including a rotation direction and a rotation angle.

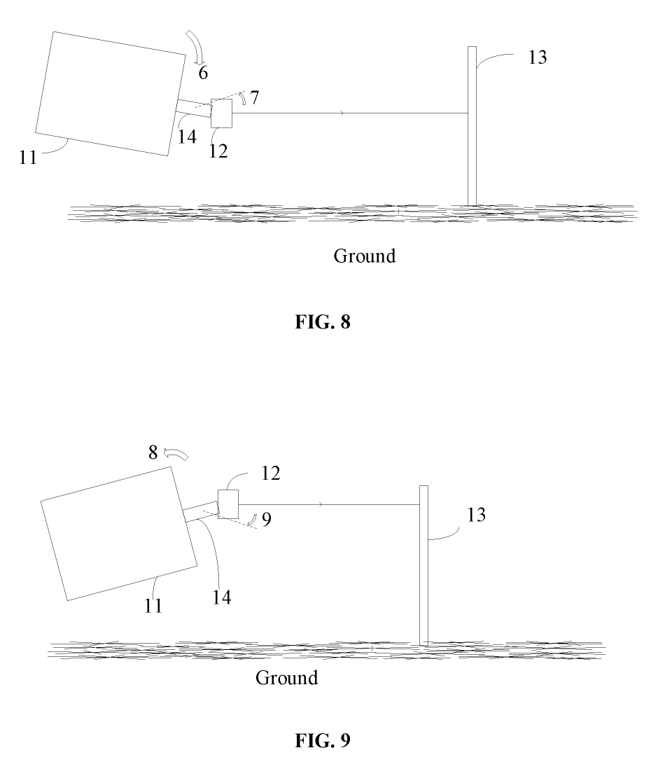

Assume that a pitch angle deviating upward with respect to the horizontal direction is in a positive direction, and a pitch angle deviating downward with respect to the horizontal direction is in a negative direction. The inertial measurement unit of the flight controller can be configured to detect the pitch angle of the UAV in a real-time manner. As shown in FIG. 8, when the pitch angle (arrow 6, which indicates a first pitch angle direction of the craft body 11) of the UAV is negative, the flight controller can control the rotation apparatus 14 to rotate in the positive direction (e.g., with a positive rotation angle) (arrow 7, which indicates a third rotation direction of the rotation apparatus 14), i.e., the rotation angle of the rotation apparatus 14 is positive. The detection apparatus 12 can rotate along with the rotation of the rotation apparatus 14. When the detection apparatus 12 rotates to adjust the detection direction of the detection apparatus 12, the detection direction of the detection apparatus 12 can be kept in the horizontal direction. As such, the detection apparatus 12 can accurately detect an obstacle 13 in front of the UAV. In some embodiments, a magnitude of the rotation angle of the rotation apparatus 14 can be equal to a magnitude of the current pitch angle of the UAV.

As shown in FIG. 9, the current pitch angle (arrow 8, which indicates a second pitch angle direction of the craft body 11) of the UAV is positive. The flight controller can control the rotation apparatus 14 to rotate in the negative direction (e.g., with a negative rotation angle) (arrow 9, which indicates a fourth rotation direction of the rotation apparatus 14), i.e., the rotation angle of the rotation apparatus 14 is controlled to be negative. The detection apparatus 12 can rotates along with the rotation of the rotation apparatus 14. When the detection apparatus 12 rotates to adjust the detection direction of the detection apparatus 12, the detection direction of the detection apparatus 12 can be kept in the horizontal direction. As such, the detection apparatus 12 can accurately detect the obstacle 13 in front of the UAV. In some embodiments, the magnitude of the rotation angle of the rotation apparatus 14 can be equal to the magnitude of the current pitch angle of the UAV.

In some embodiments, the detection apparatus 12 can be a radar, and the rotation apparatus 14 can be a steering gear.

In the above embodiments, the detection apparatus can be attached to (or mounted at) the craft body through the rotation apparatus. The rotation apparatus can rotate upward with respect to the horizontal direction and can also rotate downward with respect to the horizontal direction. The detection apparatus can rotate along with the rotation of the rotation apparatus. When the pitch angle of the UAV is positive, the rotation apparatus is controlled to rotate in the negative direction (e.g., with a negative rotation angle). When the pitch angle of the UAV is negative, the rotation apparatus is controlled to rotate in the positive direction (e.g., with a positive rotation angle). The magnitude of the pitch angle of the UAV is equal to the magnitude of the rotation angle of the rotation apparatus. Thus, the detection direction of the detection apparatus can be kept in the horizontal direction. As such, the detection apparatus can accurately detect the obstacle in front of the UAV, thereby improving the safety of the UAV during flight.

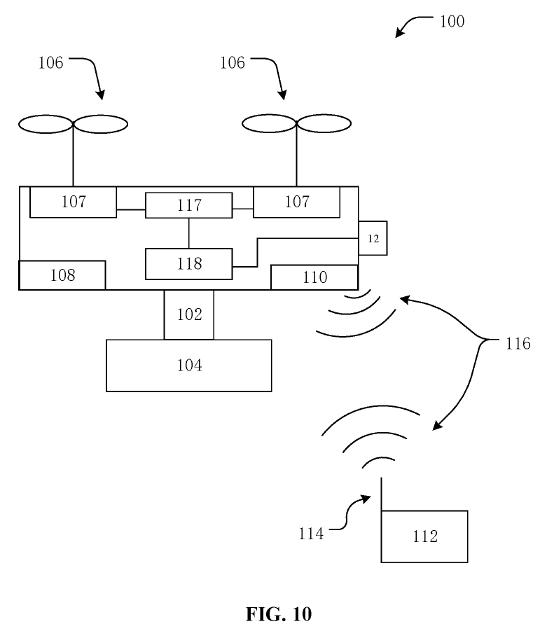

Another aspect of the present disclosure provides a UAV. FIG. 10 is a structural diagram of an example of a UAV 100 according to embodiments of the present disclosure. As shown in FIG. 10, the UAV 100 includes a craft body, a propulsion system, a flight controller 118, and a detection apparatus 12. The propulsion system includes one or more of: a motor 107, a propeller 106, and an electronic speed control 117. The propulsion system is mounted to the craft body and configured to provide a flight power. The flight controller 118 is communicatively connected to the propulsion system and configured to control the flight of the UAV 100. The detection apparatus 12 is attached to the craft body and can be configured to detect obstacles near the UAV 100.

The flight controller 118 includes an inertial measurement unit and a gyroscope. The inertial measurement unit and the gyroscope can be configured to detect an acceleration, a pitch angle, a roll angle, a yaw angle, etc. of the UAV. The flight controller 118 is connected to the detection apparatus 12 and can also be configured to detect a pitch angle, a roll angle, and a yaw angle of the detection apparatus 12. The flight controller 118 can be configured to obtain a current attitude information of the UAV and control the detection direction of the detection apparatus 12 according to the current attitude information of the UAV, so that the detection direction of the detection apparatus 12 can be in a preset direction.

The current attitude information of the UAV includes one or more of: current attitude information of the craft body, and current attitude information of the detection apparatus 12. The attitude information includes one or more of: the pitch angle, the roll angle, and the yaw angle.

In some embodiments, the detection direction of the detection apparatus 12 can be kept in the horizontal direction; or the detection direction of the detection apparatus 12 changes with the change in the pitch angle of the craft body first, and then adjust to the preset direction.

In some embodiments, the flight controller 118 can control the detection direction of the detection apparatus 12 in different manners.

In one example, the current attitude information of the UAV is the pitch angle of the detection apparatus, and the detection direction of the detection apparatus is controlled by the flight controller 118 according to the pitch angle of the detection apparatus

In another example, the current attitude information of the UAV is the pitch angle of the UAV, and the detection direction of the detection apparatus is controlled by the flight controller 118 according to the pitch angle of the UAV.

The flight controller 118 may control the detection direction of the detection apparatus 12 by controlling the rotation of the detection apparatus 12 so that the detection direction of the detection apparatus 12 is the same as the horizontal direction.

In addition, as shown in FIG. 10, the UAV 100 further includes: a sensing system 108, a communication system 110, a supporting apparatus 102, and a photographing apparatus 104. The supporting apparatus 102 may be a gimbal, and the communication system 110 may be a receiver. The receiver can be configured to receive wireless signals transmitted by an antenna 114 of a ground station 112. Electromagnetic waves 116 can be generated during communication between the receiver and the antenna 114.

The specific principle and implementation manner of the UAV consistent with the present disclosure are similar to embodiments described above in connection with FIG. 4, and therefore are not described herein again.

According to the current attitude information of the UAV, the detection direction of the detection apparatus can be controlled to ensure the detection direction of the detection apparatus is in a preset direction, e.g., the horizontal direction. Thus, the detection direction of the detection apparatus does not change along with the change of the current attitude of the UAV. As such, the detection apparatus can accurately detect the obstacle in front of the UAV, thereby improving the safety of the UAV during flight.

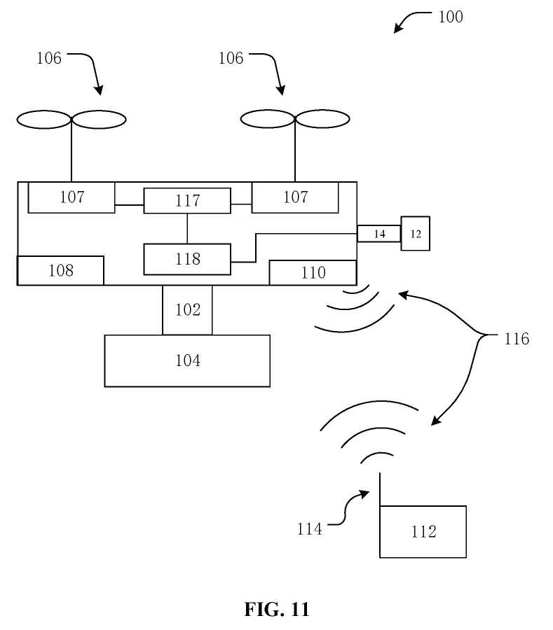

FIG. 11 is a structural diagram of another example of the UAV 100 according to some other embodiments of the present disclosure. The UAV 100 shown in FIG. 11 is similar to the UAV 100 shown in FIG. 10, except that the UAV 100 shown in FIG. 11 further includes a rotation apparatus 14. The detection apparatus 12 can be attached to the craft body through the rotation apparatus 14. The flight controller 118 can be configured to control the rotation of the rotation apparatus 14, so as to control the detection direction of the detection apparatus 12. As such, the detection direction of the detection apparatus 12 can be the same as the horizontal direction.

The flight controller 118 can control the rotation of the rotation apparatus 14. For example, when the current pitch angle of the UAV 100 is positive, the flight controller 118 can control the rotation apparatus 14 to rotate with a negative rotation angle. When the current pitch of the UAV 100 is negative, the flight controller 118 can control the rotation apparatus 14 to rotate with a positive rotation angle. In addition, in some embodiments, the magnitude of the current pitch angle of the UAV is equal to the magnitude of the rotation angle of the rotation apparatus.

In some embodiments, the detection apparatus 12 can be a radar and the rotation apparatus 14 can be a steering gear.

The specific principle and implementation manner of the UAV consistent with the present disclosure are similar to embodiments described above in connection with FIG. 7, and therefore are not described herein again.

In the above embodiments, the detection apparatus can be attached to the craft body through the rotation apparatus. The rotation apparatus can rotate upward with respect to the horizontal direction and can also rotate downward with respect to the horizontal direction. The detection apparatus can rotate along with the rotation of the rotation apparatus. When the pitch angle of the UAV is positive, the rotation apparatus is controlled to rotate in the negative direction (e.g. with a negative rotation angle). When the pitch angle of the UAV is negative, the rotation apparatus is controlled to rotate in the positive direction (e.g., with a positive rotation angle). The pitch angle of the UAV is equal to the rotation angle of the rotation apparatus. Thus, the detection direction of the detection apparatus can be kept in the horizontal direction. As such, the detection apparatus can accurately detect the obstacle in front of the UAV, thereby improving the safety of the UAV during flight.

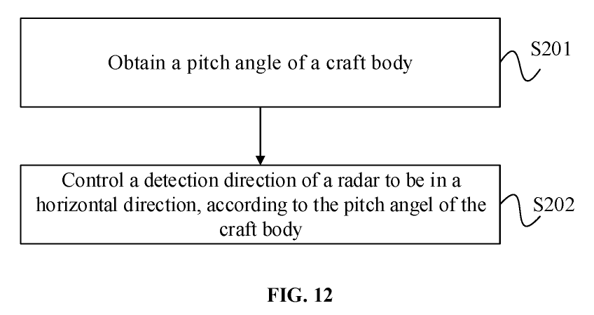

Another aspect of the present disclosure provides a method of controlling obstacle avoidance for an agricultural UAV. FIG. 12 is a flowchart of a method of controlling the obstacle avoidance for the agricultural UAV according to some embodiments of the present disclosure. As shown in FIG. 12, at S201, a pitch angle of the craft body is obtained.

In some embodiments, the agricultural UAV may include a craft body and a radar disposed at the craft body. The radar can be configured to detect an obstacle in front of the UAV.

A flight controller of the agricultural UAV may include an inertial measurement unit and a gyroscope. The inertia measurement unit and the gyroscope can be configured to detect the acceleration, the pitch angle, the roll angle, the yaw angle, etc. of the agriculture UAV. The method of controlling the obstacle avoidance for the agriculture UAV can be executed by a flight controller or a control module with a control function in the agriculture UAV. In some embodiments, the flight controller may be configured to execute the method. The flight controller may be configured to obtain the pitch angle of the craft body through an inertial measurement unit.

At S202, the detection direction of the radar can be controlled according to the pitch angle of the craft body, so that the detection direction can be in a horizontal direction.

The flight controller controls the detection direction of the radar according to the pitch angle of the craft body.

The flight controller can control the detection direction of the radar in different manners.

In one example, the flight controller controls the radar to rotate, so that the detection direction of the radar can be in the horizontal direction. As shown in FIG. 5 and FIG. 6, the detection apparatus 12 is the radar. When the pitch angle of the craft body 11 is positive, the flight controller controls the radar to rotate in a negative direction (e.g., with a negative rotation angle). When the pitch angle of the craft body 11 is negative, the flight controller controls the radar to rotate in the positive direction (e.g., with a positive rotation angle). As such, the detection direction of the radar can be in the horizontal direction.

In another example, the radar can be attached to the craft body 11 through the steering gear. The flight controller controls the steering gear to rotate, so that the detection direction of the radar can be in the horizontal direction. As shown in FIG. 7, the rotation apparatus 14 is the steering gear, and the detection apparatus 12 (i.e., the radar) is attached to the craft body 11 through the steering gear. The steering gear is able to rotate upward with respect to the horizontal direction (along the arrow 4, which indicates the first rotation direction of the rotation apparatus 14) and rotate downward with respect to the horizontal direction (along the arrow 5, which indicates the second rotation direction of the rotation apparatus 14).

When the steering gear rotates, the radar rotates along with the steering gear. Therefore, the flight controller can also control the detection direction of the radar by controlling the rotation of the steering gear.

Assume that a pitch angle deviating upward with respect to the horizontal direction is a positive direction, and a pitch angle deviating downward with respect to the horizontal direction is a negative direction. The inertial measurement unit of the flight controller can be configured to detect the pitch angle of the UAV in a real-time manner. When the current pitch angle of the craft body is positive, the flight controller controls the steering gear to rotate in the negative direction (e.g., with a negative rotation angle), as shown in FIG. 9. When the current pitch angle of the craft body is negative, the flight controller controls the steering gear to rotate in the positive direction (e.g., with a positive rotation angle), as shown in FIG. 8. In some embodiments, the magnitude of the rotation angle of the rotation apparatus 14 can be equal to the magnitude of the current pitch angle of the steering gear.

According to the current attitude information of the UAV, the detection direction of the detection apparatus can be controlled to ensure that the detection direction of the detection apparatus is in a preset direction, e.g., the horizontal direction. Thus, the detection direction of the detection apparatus does not change along with the change of the current attitude of the UAV. As such, the detection apparatus can accurately detect the obstacle in front of the UAV, thereby improving the safety of the UAV during flight.

Another aspect of the present disclosure provides an agriculture UAV. As shown in FIG. 10, the UAV 100 is an agriculture UAV according to embodiments of the present disclosure, the agriculture UAV includes a craft body, a propulsion system, a flight controller 118, and a detection apparatus 12. The propulsion system includes one or more of: a motor 107, a propeller 106, and an electronic speed control 117. The propulsion system is mounted to the craft body and configured to provide a flight power. The flight controller 118 is communicatively connected to the propulsion system and configured to control the flight of the UAV 100. The detection apparatus 12 is mounted to the craft body and can be configured to detect obstacles near the UAV 100.

The flight controller 118 includes an inertial measurement unit and a gyroscope. The inertial measurement unit and the gyroscope can be configured to detect an acceleration, a pitch angle, a roll angle, a yaw angle, etc. of the agricultural UAV. The flight controller 118 can be configured to obtain a current attitude information of the UAV, and control the detection direction of the detection apparatus 12 according to the current attitude information of the UAV, so that the detection direction of the detection apparatus 12 can be in a preset direction.

In some embodiments, the flight controller 118 can control the detection direction of the detection apparatus 12 (i.e., the radar) in different manners.

In one example, the flight controller 118 the flight controller controls the radar 12 to rotate, so that the detection direction of the radar 12 can be in the horizontal direction.

In another example, as shown in FIG. 11, the radar 12 can be attached to the craft body 11 through the steering gear 14. The flight controller 118 controls the steering gear 14 to rotate, so that the detection direction of the radar 12 can be in the horizontal direction.

In some embodiments, the current pitch angle of the craft body is positive, and the flight controller 118 controls the steering gear 14 to rotate with a negative rotation angle. In some other embodiments, the current pitch angle of the craft body is negative, and the flight controller 118 controls the steering gear 14 to rotate with a positive angle.

In some embodiments, the magnitude of the current pitch angle of the craft body is equal to the magnitude of the steering angle of the steering gear 14.

In addition, as shown in FIG. 10 or FIG. 11, the agricultural UAV also includes a sensing system 108, a communication system 110, a supporting apparatus 102, and a photographing apparatus 104. The supporting apparatus 102 may be a gimbal, and the communication system 110 may be a receiver. The receiver can be configured to receive wireless signals transmitted by an antenna 114 of a ground station 112. Electromagnetic waves 116 can be generated during communication between the receiver and the antenna 114.

The specific principle and implementation manner of the agriculture UAV consistent with the present disclosure are similar to embodiments described above in connection with FIG. 12, and therefore are not described herein again.

According to the current attitude information of the UAV, the detection direction of the detection apparatus can be controlled to ensure the detection direction of the detection apparatus is in a preset direction, e.g., the horizontal direction. Thus, the detection direction of the detection apparatus does not change along with the change of the current attitude of the UAV. As such, the detection apparatus can accurately detect the obstacle in front of the UAV, thereby improving the safety of the UAV during flight.

The disclosed apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. Those of ordinary skill in the art will appreciate that the example elements and algorithm steps described above can be implemented in electronic hardware, or in a combination of computer software and electronic hardware.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random-access memory (RAM), a magnetic disk, or an optical disk.

For simplification purposes, the division of the foregoing functional units is used as an example for illustration. In practical applications, the above functions may be distributed by different functional units according to actual conditions. An internal structure of the example apparatus can be divided into different functional units to complete all or partial of the functions described above. For the specific working process of the example apparatus described above in the device embodiments, reference may be made to the description of the method embodiments, and details are not described herein again.

It is intended that the specification and embodiments be considered as examples only and not to limit the scope of the disclosure. Any modification and equivalently replacement for the technical solution of the present disclosure should all fall in the spirit and scope of the technical solution of the present disclosure.

What is claimed is:

1. A method of controlling obstacle avoidance for an unmanned aerial vehicle (UAV) comprising:
obtaining current attitude information of the UAV, the UAV including a craft bodycraft body and a detection apparatus attached to the craft body; and
controlling a detection direction of the detection apparatus to be in a preset direction, according to the current attitude information of the UAV.

2. The method according to claim 1, wherein obtaining the current attitude information of the UAV comprises obtaining at least one of current attitude information of the craft body or current attitude information of the detection apparatus.

3. The method according to claim 2, wherein controlling the detection direction of the detection apparatus to be in the preset direction comprises:
maintaining the detection direction of the detection apparatus to be in a horizontal direction; or
changing the detection direction of the detection apparatus along with an attitude change of the craft body and controlling the detection direction of the detection apparatus to be in the preset direction.

4. The method according to claim 2, wherein obtaining the current attitude information of the UAV comprises obtaining one or more of a current pitch angle of the UAV, a current roll angle of the UAV, and a current yaw angle of the UAV.

5. The method according to claim 4, wherein:
obtaining the current attitude information of the UAV comprises obtaining a current pitch angle of the detection apparatus; and
controlling the detection direction of the detection apparatus comprises controlling the detection direction of the detection apparatus to be in the preset direction, according to the current pitch angle of the detection apparatus.

6. The method according to claim 4, wherein:
obtaining the current attitude information of the UAV comprises obtaining a current pitch angle of the craft body; and
controlling the detection direction of the detection apparatus comprises controlling the detection direction of the detection apparatus to be in the preset direction, according to the current pitch angle of the craft body.

7. The method according to claim 1, wherein controlling the detection direction of the detection apparatus comprises controlling the detection apparatus to rotate to allow the detection direction of the detection apparatus to be in the horizontal direction.

8. The method according to claim 1, wherein the detection apparatus is attached to the craft body through a rotation apparatus.

9. The method according to claim 8, wherein controlling the detection direction of the detection apparatus comprises controlling the rotation apparatus to rotate to allow the detection direction of the detection apparatus to be in a horizontal direction.

10. The method according to claim 9, wherein controlling the rotation apparatus to rotate comprises:
controlling the rotation apparatus to rotate with a negative rotation angle, in response to a current pitch angle of the UAV being positive; or
controlling the rotation apparatus to rotate with a positive rotation angle, in response to a current pitch angle of the UAV being negative.

11. An unmanned aerial vehicle (UAV) comprising:
a craft body;
a propulsion system mounted at the craft body and configured to provide a flight power;
a detection apparatus mounted at the craft body and configured to detect an obstacle near the UAV; and
a flight controller communicatively connected to the propulsion system and the detection apparatus, and configured to:
obtain current attitude information of the UAV; and
control a detection direction of the detection apparatus to be in a preset direction, according to the current attitude information of the UAV.

12. The UAV according to claim 11, wherein the current attitude information of the UAV comprises one or more of current attitude information of the craft body or current attitude information of the detection apparatus.

13. The unmanned aerial vehicle according to claim 12, wherein the flight controller is further configured to:
maintain the detection direction of the detection apparatus to be in a horizontal direction; or
change the detection direction of the detection apparatus along with an attitude change of the craft body and control the detection direction of the apparatus to be in the preset direction.

14. The UAV according to claim 12, wherein the current attitude information of the UAV comprises one or more of a current pitch angle of the UAV, a current roll angle of the UAV, and a current yaw angle of the UAV.

15. The UAV according to claim 14, wherein the current attitude information of the UAV is a current pitch angle of the detection apparatus, the flight controller is further configured to:
obtain the current pitch angle of the detection apparatus; and
control the detection direction of the detection apparatus to be in the preset direction, according to the current pitch angle of the detection apparatus.

16. A method of controlling obstacle avoidance for an agricultural unmanned aerial vehicle (UAV) comprising:
obtaining a current pitch angle of a craft body of the agricultural UAV, the agricultural UAV including a craft body and a radar attached to the craft body; and
controlling a detection direction of the radar of the agricultural UAV to be in a horizontal direction, according to the current pitch angle of the craft body.

17. The method according to claim 16, wherein controlling the detection direction of the radar comprises controlling the radar to rotate to allow the detection direction of the radar to be in the horizontal direction.

18. The method according to claim 16, wherein the radar is mounted to the craft body through a steering gear.

19. The method according to claim 18, wherein controlling the detection direction of the radar comprises controlling the steering gear to rotate to allow the detection direction of the radar to be in the horizontal direction

20. The method according to claim 19, wherein controlling the steering gear to rotate comprises:
controlling the steering gear to rotate with a negative rotation angle, in response to the current pitch angle of the craft body being positive; or
controlling the steering gear to rotate with a positive rotation angle, in response to the current pitch angle of the craft body being negative.
